(19) United States
(12) Patent Application Publication
(10) Pub. No.: US 2008/0252781 A1
(43) Pub. Date: Oct. 16, 2008

(54) Imcorporation and Extraction of a Seed Linked to a Television Signal for Pseudo-Random Noise Generation

(75) Inventors: Stijn De Waele, Eindhoven (NL); Wilhelmus Hendrikus Alfonsus Bruls, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,998

(22) PCT Filed: Mar. 10, 2005
(86) PCT No.: PCT/IB2005/050867

§ 371 Date: Sep. 18, 2006

(30) Foreign Application Priority Data
Mar. 19, 2004 (EP) 04101141.2

(51) Int. Cl. H04N 5/04; H04N 5/00

(52) U.S. Cl. 348/500; 386/125; 348/E05.009

(57) ABSTRACT

The television signal (TS) comprising picture data (P1), in which television signal furthermore a predetermined seed is comprised (S1), usable for initiating a pseudorandom generator yielding a deterministic sequence of random values to be used for adding noise to the picture data, solves the problem of arbitrary look for different receiving apparatuses, each with their own generated pseudo-random noise.

The invention relates to a television signal.

The invention also relates to a data carrier comprising such a television signal.

The invention also relates to a signal-processing unit arranged to handle such a television signal.

The invention also relates to a disk reader apparatus compatible with such a data carrier.

The invention also relates to a television signal receiving system comprising the signal-processing unit.

The invention also relates to a method of supplying an output picture signal from such a television signal.

The invention also relates to software for such a method.

The invention also relates to a method for generating such a television signal.

In prior art of motion picture generation, there are basically two usual ways of capturing pictures. The first one is with a photographical emulsion, and the second one is electronic capturing, currently typically with a CCD device. The motion pictures generated by either device are perceptually dissimilar in a number of aspects, in particular they have different noise characteristics. In electronic capturing the noise is largely electronic in nature, which can be approximated by a Gaussian variable per pixel. In photographically generated material, the noise is different in nature. Emulsions contain silver halide particles of varying sizes, with an average size dependent on the sensitivity of the emulsion (daylight emulsions having smaller particles on average than emulsions for darker environmental illumination usage). The grey values are generated depending upon the statistics of how many particles of each size in a particular region of the emulsion are activated by at least a few impinging photons. The final appearance of this process is a picture containing noise, which can be modeled by a spatially correlated noise extending over neighboring picture elements (e.g. pixels in a digital representation). Note that the term noise tends to have different meanings, ranging from a single stochastic value added per pixel separately to spatially correlated or patterned noise. In this text the terms film grain and noise are used alternatively, indicating to the skilled person that the presently described technology may both work with single pixel noise (as for CCD sensors) and spatially correlated noise (as may originate e.g. from sending a noise sequence through a spatial filter and adding filtered values to picture pixels).

U.S. Pat. No. 5,917,609 describes the compression of picture object data and noise separately, and the addition of the noise on the de-compressor side. Noise is difficult to compress since it is at odds with the rationale of compression. Normally noise is not coded, since a viewer does not want to see it anyway. Current compression standards (MPEG, AVC, . . . ) typically use frequency based coding (a discrete cosine transform DCT), in which the high frequencies are rejected, high frequencies which typically represent noise. However, recently there is a trend, particularly among the content providers, to re-introduce the noise, at least the noise of photographic emulsions called film grain/noise. Firstly this gives an artistic, original look-and-feel to the motion picture material, and secondly an adverse effect of compression, reduced sharpness, is partially compensated by the introduction of noise.

Since the silver halide particles may have been anywhere inside the actually used emulsion, the gist of U.S. Pat. No. 5,917,609 is that high compression for the noise can be achieved. The noise does not have to be regenerated in the actual configuration it appeared to be in the captured picture, rather any noise distribution with the statistical properties of the used emulsion (amplitude, correlation, etc.) will do. So instead of coding the noise, it can be regenerated with a noise generator equation and added to the compressed object data at the de-compressor side.

It is an object of the invention to provide a possibility of predictable noise regeneration at the television signal receiving side.

The inventors had an insight that it is a disadvantage of the approach according to U.S. Pat. No. 5,917,609 that different reproductions of a motion picture (by different receivers or by the same receiver for different reproduction instances) result in different visual appearances due to the stochastic noise addition, i.e. there is no control over what is actually produced at the de-compressor side.

The object of the present invention is realized in that the television signal comprising picture data furthermore comprises a predetermined seed, usable for initiating a pseudo-random generator yielding a deterministic sequence of random values to be used for adding noise to the picture data.

Pseudo-random noise generators have the property that they produce a sequence of noise values in a predetermined, deterministic order. Deterministic in the context of this text should be considered as follows. Random generators typically work by applying a so-called transition function f to a previous pseudo-random realization rₙ₋₁ to obtain a current realization rₙ:

rₙ=f(rₙ₋₁)

Deterministic means that given an initial value—called a seed—r₀, for the same seed the same sequence of pseudo-random values is obtained, i.e. this sequence is fully predetermined by one or more seeds (the latter being the case for equations which generate the current realization depending upon several previous realizations). This should not be confused with the indication deterministic signifying that there is at least a weak inter-sample correlation, making the sequence not perfectly random, which may be suspected if the sequence is generated by a simple mathematical formula. Whereas this may be problematic for cryptography, film grain noise addition is rather forgiving in that it is sufficient when the successive values in the sequence seem rather random, i.e. they cannot easily be predicted. Also the probability distribution of the random noise values need not be exactly Gaussian.

Supplying a predetermined seed in the television signal, which is subsequently used by each receiving apparatus having a same pseudo-random generator, guarantees that the resulting output picture signal, resulting from adding on an element-by-element basis the generated noise values to data picture elements (e.g. object pixels in a digital representation, or a region of a scan line in an analog representation) taken from the picture data, is the same for each reproduction. Hence a content provider need not worry that in a particular receiver e.g. a visually unpleasant noise value is generated over a character form a subtitle, rather this can be pre-checked at the transmitter side, or even in a production studio long before transmission.

It does seem at odds with the principle of generating noise at the receiver side, which is supposed to be inherently random, to make the noise somewhat deterministic again. However it is an insight of the inventors that this may be desirable, and that the object can be achieved with relatively little modification of the television signal.

An embodiment of the television signal contains several seeds for corresponding groups of pictures. Instead of sending a single seed at the beginning of the motion picture, it is advantageous if at consecutive time instants a new seed is sent. This is advantageous for a receiver which reads only a part of the motion picture, because with this measure the receiver will not have lost the seed but rather will soon encounter a new seed. This signal embodiment may be interesting for trick-play. E.g. fast-forward on compressed motion picture material may typically only read the first I pictures (intra-pictures) of consecutive groups of pictures (GOPs). In this case it is advantageous to send a new seed for each first I picture.

Another embodiment of the television signal comprises for at least one picture several seeds, usable for generating noise for different spatial regions of the at least one picture.

This signal embodiment is useful from the point of view of the content provider. If a human operator has to check the quality of the added noise with a particular seed, although the generation of noise values is quickly done, the checking of a picture is very labor-intensive. Hence if the human operator perceives that in a part of a picture the noise looks ugly, rather than calculating noise with a new seed for the entire picture (and having to check the whole picture again to see if there is not now an artifact in another region of the picture), he has the option to define a new seed and recalculate the noise only for the problematic region. The extra seed will be stored together with a geometrical indication of the region, e.g. a slice in compressed content.

A further embodiment of the television signal also comprises coefficients for tuning an algorithm of the pseudo-random generator.

The comprised seed realizes that the generated noise is deterministic, i.e. the same for all receivers. However, the statistically average look of the noise depends on the random generator equations rather than on the seed. Therefore it is useful if the content provider can also tune coefficients of the equations and simultaneously comprise them in the signal. In this way he has a fuller control over the exact film look of the motion picture at the receiver side. Coefficients may be e.g. the amplitude in number of grey values of the noise, coefficients for filtering determining the spatial correlation of the noise etc.

An even more advanced embodiment of the television signal comprises also at least one random generator type indicator, indicating a specific one of a plurality of supported pseudo-random generators. This way the content provider may also preselect from a number of different pseudo-random generator algorithms, upon which the receiving device switches to the preselected pseudo-random generator for generating the film noise. E.g. if the human operator considers that the noise generated by a simple linear congruential generator provides a sufficient artistic look, he may set the type indicator to a value corresponding to this linear congruental generator (or alternatively the absence of a particular type indicator may signify the use of this generator as a fallback option). Alternatively, in case he is not yet pleased with the artistic results, he may generate (for the whole motion picture, or for subsets of pictures, e.g. those being part of a single shot) the noise with an alternative generator (e.g. deterministic random sampling from a prerecorded film grain noise picture) and send a type indicator signaling that this alternative random generator should be used by the receivers.

A versatile embodiment of the television signal comprises at least two alternative seeds (and if appropriate also alternative sets of coefficients), in which a first alternative seed (S1) is to be used for a first supported pseudo-random generator or alternatively a second alternative seed (S11) is to be used for a second supported pseudo-random generator.

This embodiment is useful from the point of view of the receiver manufacturer. A first manufacturer of a cheap device may wish to use a simple pseudo-random generator, whereas a manufacturer of a high-end receiver may prefer the usage of a high quality random generator. The content provider may not be able to avoid this, but may still want his content to look artistic. With this signal he is able to control the look for different pseudo-random generators simultaneously, by transmitting alternative seeds for the supported alternative pseudo-random generators.

It should be clear to the skilled person that the distinguishing elements of the various previous television signal embodiments may be combined and furthermore the picture data for each of the embodiments may be in compressed form. As described in the introduction, noise addition is particularly interesting for compressed motion picture data.

A compression for which the seed incorporation may be of particular interest is the advanced video coding (AVC) standardized by the Joint Video Team (JVT) of ISO/IEC MPEG & ITU-T VCEG (ISO/IEC JTC1/SC29/WG11 and ITU-T SG16 Q.6).

The television signal may be broadcasted over terrestrial broadcast, satellite, cable, telephone network, etc., but may also be put on a data carrier, in particular a blue-ray disk (information about the standardization consortium of founder Philips, Sony, Matsushita, etc. can be found on http://www.blu-ray.com/).

What is required on the receiving side is a signal processing unit arranged to deal with the particularities of the new television signal, i.e. arranged to receive the television signal, and further comprising extraction means arranged to:

extract data picture elements from the picture data in the television signal; and

extract the seed from the television signal,

and video processing means, comprising:

a pseudo-random generator arranged to generate a pseudo-random noise sequence of noise picture elements based upon the seed; and

adding means arranged to add the noise picture elements to the data picture elements on an element-by-element basis, yielding an output picture signal to be displayed.

Hence this apparatus is led in its film noise addition by the instructions in the television signal, in particular the seed. This unit may e.g. be a part of a dedicated ASIC, or software running on a generic or special purpose processor incorporated in the receiver.

In an embodiment of the signal-processing unit capable of handling the embodiment of the television signal with different seeds for respective groups of pictures, the extraction means is arranged to extract a new seed for consecutive time instants, and the pseudo-random generator is arranged to restart a pseudo-random noise sequence generation for each new seed. This way the apparatus is can extract the required seed when it reads only part of the motion picture.

In another embodiment of the signal processing unit, the extraction means is arranged to extract several seeds for a picture, the pseudo-random generator is arranged to generate a pseudo-random noise sequence corresponding to each of the several seeds, and the video processing means is arranged to add the noise picture elements based upon the different seeds to respective different regions of the picture. This way the unit can add different optimized noise patches to the picture, as intended by the content provider.

A further embodiment of the signal-processing unit has the extraction means further arranged to extract coefficients, and he pseudo-random generator arranged to adapt its algorithm for generating the pseudo-random noise sequence upon the coefficients. E.g. different filter coefficients may have been transmitted in the television signal for tuning the spatial correlation of the film noise.

A versatile embodiment of the signal-processing unit comprises extraction means which are further arranged to extract a random generator type indicator, and has the video processing means arranged to select a particular of a number of supported random generation algorithms in dependence upon the type indicator.

If different pseudo-random generators are supported in the signal processing units of the receivers, the content provider can select that one which according to his preference gives the best results. On the other hand, a receiver having different pseudo-random generators may select a particular one based on its own rationale, in particular if the signal supports alternative options, all giving satisfactory results.

This signal processing unit is typically comprised in a disk reader apparatus further comprising:

a data carrier input unit for inputting a data carrier as above, further capable of extracting from the data carrier the television signal; and

a television signal output arranged to transfer the output picture signal resulting from the signal processing unit to a display.

Examples of disk reader apparatuses are apparatuses which are known as disk reader, i.e. in particular a blue-ray disk reader, but also combination apparatuses such as a television signal reproducer/recorder comprising apart from a blue-ray disk reading unit also e.g. a hard disk, or a set-top-box also comprising a blue-ray disk reading unit. In fact under disk reader apparatus should be read any apparatus having disk reading capability, i.e. typically comprising a disk reader unit.

The signal processing unit may also be comprised in a television signal receiving system further comprising a receiving unit arranged to receive from a wired or wireless connection to a television data source the television signal, and the signal processing unit being arranged receive the television signal from the receiving unit and to supply the output picture signal containing generated noise.

A display may be comprised in the television signal receiving system, which display receives the supplied output picture signal.

Examples of such a television signal receiving system are:

a single-box CRT based television receiver;

a system comprising a set-top-box for receiving and processing (including film noise addition) the television signal connected to a standard e.g. LCD display; or

a professional receiving system of a provider or distributor.

Variants of this television system may be constructed similarly to the variants of the disk reader apparatus.

A method of supplying an output picture signal is also disclosed, comprising:

receiving a television signal as claimed in claim 1;

extracting data picture elements from the picture data in the television signal;

extracting the seed from the television signal,

generating a pseudo-random noise sequence of noise picture elements based upon the seed; and

adding the noise picture elements to the data picture elements on an element-by-element basis, yielding the output picture signal,

as well as a computer program product comprising code enabling a processor to execute the method of claim 13.

Finally a method of incorporating a seed in the television signal is advantageous, the method comprising:

S1) fetching data picture elements;

S2) generating noise picture elements for at least one selected seed;

S3) adding the noise picture elements to the data picture elements yielding an output picture signal;

S4) analyzing the output picture signal by a human operator, or automatically analyzing the noise addition according to a predetermined quality determination method applying pre-programmed heuristics, either method yielding a decision output equal to PASS or FAIL;

S5) automatically incorporating the currently selected and analyzed seed in the television signal if the decision output equals PASS, and continuing with the second step S2 for a new selected seed if the decision output equals FAIL.

This is a matching method on the production side allowing the creation of the television signal, i.e. allowing the content producer/verifier to incorporate at least one seed according to his liking into the television signal.

These and other aspects of the television signal, signal processing unit and disk reader apparatus according to the invention will be apparent from and elucidated with reference to the implementations and embodiments described hereinafter, and with reference to the accompanying drawings, which serve merely as non-limiting specific illustrations exemplifying the more general concept, and in which dashes are used to indicate that a component is optional.

In the Drawings:

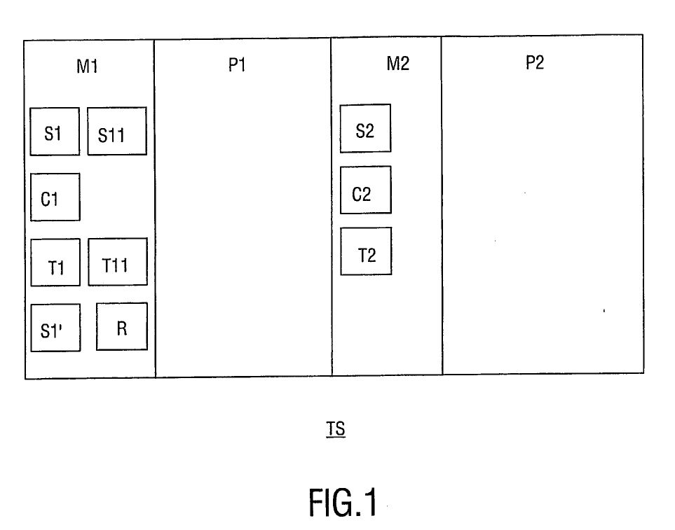

FIG. 1 schematically shows the television signal;

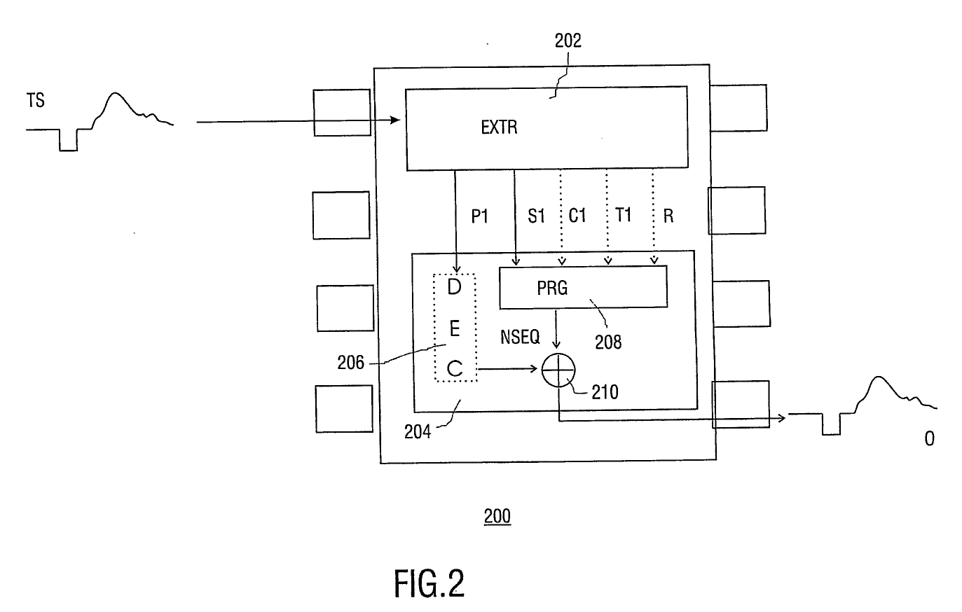

FIG. 2 schematically shows an embodiment of the signal processing unit; and

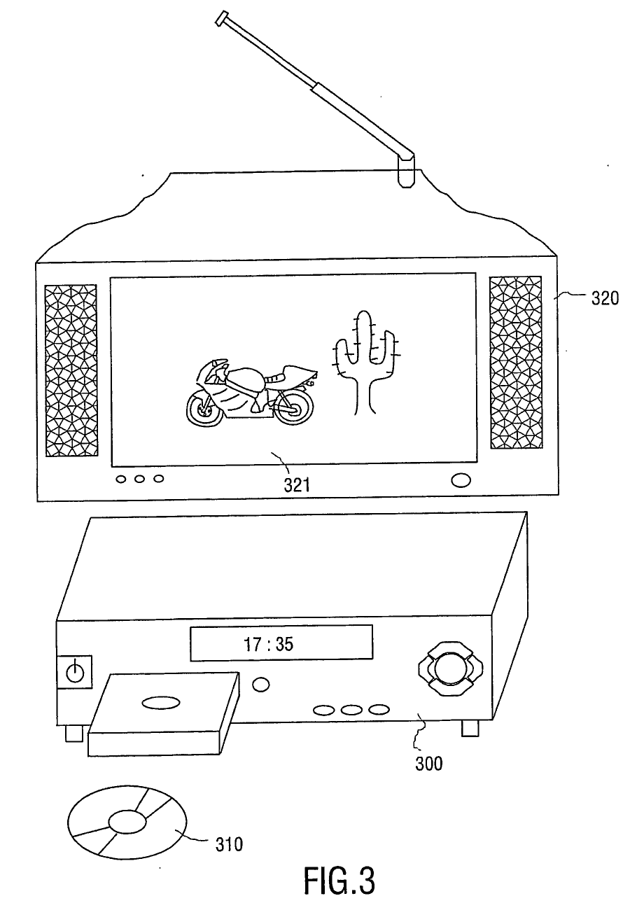

FIG. 3 schematically shows an embodiment of the disk reader apparatus and the television signal receiving system.

In FIG. 1, a television signal TS according to the invention is shown in a digital form, e.g. “Advanced video coding” (AVC) compressed. The signal is composed of metadata M1, M2 (e.g. header, compression parameters, . . . , and according to the present invention also at least one seed S1), interleaved with picture data P1, P2 describing objects in a captured scene, typically numbers indicating e.g. discrete Fourier transform coefficients for blocks of pixels. It should be easy for the skilled person to realize what e.g. an analog equivalent of the television signal TS would look like, wherein metadata typically resides in the blanking lines, in which there is still space for additional data.

E.g., the current proposed version of AVC contains so-called supplemental enhancement information (SEI) with film grain semantics.

In this standard it is possible to specify a film noise generation equation of the type:

$$G [ x , y , c ] = {C}_{1} n + {\sum }_{k , l} {C}_{( k , l )} G [ x - k , y - l , c ] + {\sum }_{m} {C}_{m} G [ x , y , c + m ] \qquad [ Eq . 1 ]$$

In Eq. 1 x stands for a horizontal pixel coordinate, y for a vertical pixel coordinate, c for a color plane (e.g. the Y, Cb, Cr representation being used), the C's are coefficients (constants), and G[x,y,c] is the Gaussian noise value generated for the position (x,y) in the c-th color plane. The first term C₁n is a local noise term, with n a random sample from a normalized Gaussian distribution N(0,1). The second term models spatial correlation in the c-th color plane, by weighing previously generated Gaussian noise values for previous positions (x−k, y−1). The third term models color noise, i.e. correlation between color plains [since the grains in the different emulsions do not show the exact same spatial distribution, color errors occur].

The local noise term is typically generated by a pseudo-random generator in the receiving apparatus. E.g. uniform noise is generated first, and subsequently transformed to Gaussian noise by means of the Box-Muller equation:

$${z}_{1} = \sqrt{- 2 ln {x}_{1}} cos ( 2 π {x}_{2} ) \\ {z}_{2} = \sqrt{- 2 ln {x}_{1}} sin ( 2 π {x}_{2} ) \qquad [ Eq . 2 ]$$

in which x₁ and x₂ are distributed uniformly and z₁ and z₂ normally.

The uniform noise is generated by one of a number of possible pseudo-random generators, e.g. the simple linear congruential generator:

xₙ=(axₙ₋₁+b)mod n [Eq. 3]

in which a and b and m are constants, and mod is the modulus.

This is a simple generator, although disadvantageous it generates rather highly temporally correlated sequences.

The sequence of random number is started by taking the seed S1 as the first number x₀. This seed is typically taken from with the receiving apparatus, e.g. on the basis of its current clock time value.

However, this has as a disadvantage that the visual appearance of the outputted pictures with noise will look different for different receiving apparatuses.

According to the invention, as shown in FIG. 2, a signal processing unit 200 comprised in a receiving apparatus compatible with the television signal TS—e.g. a television signal receiving system 320 [see FIG. 3] such as an LCD television receiver, or a disk reader apparatus 300 receiving the television signal on a data carrier 310—takes the seed S1 from the television signal TS to generate the pseudo-random noise values, which hence are uniquely controlled by the television signal seed S1.

Signal processing unit 200 contains an extraction means 202, which processes the signal as prescribed by the television standard used, and outputs the picture data P1 and the seed S1 to a video processing means 204. This video processing means may optionally decode/decompress the picture data P1, e.g. from MPEG, AVC etc. to consecutive pixel grey values. A pseudo-random generator 208 generates a sequence NSEQ of noise values for all pixels in consecutive pictures, until—if provided in the television signal TS—a new seed S2 is extracted, upon which the pseudo-random generator 208 contains the noise generation with the same algorithm, but restarted with a new seed. From the content provider side this may be easily realized, since the current value of the running pseudo-random noise sequence may be comprised in the television signal as new seed S2 automatically. Finally the generated noise values—e.g. for each pixel, or for a partial element of an analog television signal—are added to the pixel values (data picture elements) by adding means 208, yielding an output picture signal (O) to be displayed.

More advanced embodiments of the signal processing unit 200 may be constructed to handle more advanced embodiments of the television signal TS.

E.g. a different seed S1′ instead of S1 may be provided for a sub-region of a picture. In this case typically also region identification information R is included in the television signal (e.g. coordinates of a rectangle of pixels), which also extracted by the extraction means 202 and sent to the video processing means 204, so that the latter applies to noise values generated by the appropriately seeded pseudo-random noise sequence NSEQ to the pixels of the different regions.

In another embodiment the video processing means 204 also receive coefficients, e.g. the coefficients of Eq. 1 or Eq. 3 above. Since film grain noise tends to depend on the illumination, it is advantageous if also these coefficients are updatable regularly, per group of pictures, or even within pictures.

The video processing means may also receive an extracted pseudo-random generator type indicator T1, indicating the type of random generator algorithm.

Since as described above the random generation consists of several steps (uniform noise generation and noise shaping, and more steps may be available such as box shuffling, de-skewing, etc. as known from the prior art of pseudo-random number generation), type indicators may determine each step separately, or an entire algorithmic combination of steps. Also the type indicators may be updated regularly (T1, T2).

Also several pseudo-random generator types may be provided for in the television signal for a single (region of a) picture or for a group of pictures. Seed S1 is to be used with type T1 and seed S11 with type T11. It should be clear to the skilled person that variants of the television signal may be designed, e.g. in which some of the type indicators may be omitted, because all receiving apparatuses conform to the standard that the first seed S1 is always to be used with a particular pseudo-random generator type.

Type T1 may indicate the pseudo-random generation strategy as described above with Eqs. 1-3. Type T2 may indicate that a more advanced so-called RANROT generator is to be used in which the uniform noise generator also rotates r places to the right the bits of each number obtained, e.g. by a linear congruential generator. Or the logistic equation may be used for generating the noise sequence:

xₙ=rxₙ₋₁(1−xₙ₋₁) [Eq. 4]

Instead of using mathematical equations to generate the noise values, more advanced pseudo-random generators (e.g. type T3) may use sampling in a prerecorded picture of captured noise. This picture is large enough to supply noise for an entire motion picture. It is transmitted e.g. at the beginning of the motion picture, or may even be transmitted by the provider at particular time instants (e.g. the first Monday of each month) and stored in the receiving apparatus. It is typically constructed by capturing under a number of illumination conditions for a particular type of film emulsion a picture of a smooth white screen. The random generator in this case provides a starting position (x,y) in the captured noise picture, after which a number of neighboring noise pixels is sampled and added to the object data pixels, and a subsequent position is generated.

Type T4 may be used to indicate that noise should be sampled from a second captured noise picture corresponding to a different emulsion. These may be interchanged within a single motion picture, e.g. simulating the night sequences being captured by coarse grained film material.

If several pseudo-random generators are supported in the television signal and the signal-processing unit 200, the video processing means 204 may choose the one optional according to its own rationale.

The algorithmic components disclosed may in practice be (entirely or in part) realized as hardware (e.g. parts of an application specific IC) or as software running on a special digital signal processor, a generic processor, etc.

Under computer program product should be understood any physical realization of a collection of commands enabling a processor—generic or special purpose—, after a series of loading steps to get the commands into the processor, to execute any of the characteristic functions of an invention. In particular the computer program product may be realized as data on a carrier such as e.g. a disk or tape, data present in a memory, data traveling over a network connection—wired or wireless—, or program code on paper. Apart from program code, characteristic data required for the program may also be embodied as a computer program product.

It should be noted that the above-mentioned embodiments illustrate rather than limit the invention. Apart from combinations of elements of the invention as combined in the claims, other combinations of the elements are possible. Any combination of elements can be realized in a single dedicated element.

Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

The invention can be implemented by means of hardware or by means of software running on a processor.

1. A television signal (TS) comprising picture data and a predetermined seed, which is usable for initiating a pseudo-random generator yielding a deterministic sequence of random values to be used for adding noise to the picture data.

2. A television signal as claimed in claim 1, further comprising several seeds for respective groups of pictures.

3. A television signal as claimed in claim 1, comprising for at least one picture several seeds, usable for generating noise for respective different spatial regions of the at least one picture.

4. A television signal as claimed in claim 1, comprising coefficients for tuning an algorithm of the pseudo-random generator.

5. A television signal as claimed in claim 1, furthermore comprising a random generator type indicator, for indicating a specific one of a plurality of supported pseudo-random generators.

6. A television signal as claimed in claim 1 comprising at least two alternative seeds in which a first alternative seed is to be used for a first supported pseudo-random generator or a second alternative seed is to be used for a second supported pseudo-random generator.

7. A television signal as claimed in claim 1, comprising the picture data in compressed form.

8. A television signal as claimed in claim 7, comprising the picture data in advanced video compression compressed form.

9. A data carrier comprising a television signal as claimed in claim 1.

10. A data carrier according to the blue-ray disk specification, comprising a signal as claimed in claim 1.

11. A signal processing unit arranged to receive a television signal (TS), comprising:
extraction means (202) arranged to
extract data picture elements from the picture data in the television signal; and
extract the seed from the television signal,
and video processing means comprising
a pseudo-random generator arranged to generate a pseudo-random noise sequence of noise picture elements based upon the seed; and
adding means arranged to add the noise picture elements to the data picture elements on an element-by-element basis, yielding an output picture signal to be displayed.

12. A signal processing unit as claimed in claim 11, wherein the extraction means is arranged to extract a new seed for a consecutive time instant, and the pseudo-random generator is arranged to restart a pseudo-random noise sequence generation for the new seed.

13. A signal processing unit as claimed in claim 11, wherein the extraction means is arranged to extract several seeds for a picture, in which the pseudo-random generator is arranged to generate a pseudo-random noise sequence corresponding to each of the several seeds (S1, S1′), and in which the video processing means (204) is arranged to add the noise picture elements based upon the different seeds (S1, S1′) to respective different regions of the picture (P1).

14. A signal processing unit as claimed in claim 11, wherein the extraction means is further arranged to extract coefficients, and in which the pseudo-random generator is arranged to adapt an algorithm for generating the pseudo-random noise sequence upon the coefficients.

15. A signal processing unit as claimed in claim 11, wherein the extraction means is further arranged to extract a random generator type indicator, and in which the video processing means is arranged to select a particular of a number of supported random generation algorithms in dependence upon the type indicator.

16. A disk reader apparatus, comprising:
a data carrier input unit for inputting a data carrier and extracting from the data carrier a television signal;
a signal processing unit (200) arranged to supply the output picture signal; and
a television signal output arranged to transfer the output picture signal containing generated noise to a display.

17. A television signal receiving system, comprising:
a receiving unit arranged to receive from a wired or wireless connection to a television data source a television signal; and
a signal processing unit arranged to receive the television signal from the receiving unit and to supply the output picture signal containing generated noise.

18. A method of supplying an output picture signal, comprising:
receiving a television signal;
extracting data picture elements from the picture data in the television signal;
extracting the seed from the television signal;
generating a pseudo-random noise sequence of noise picture elements based upon the seed; and
adding the noise picture elements to the data picture elements on an element-by-element basis, yielding the output picture signal.

19. A computer program product comprising code enabling a processor to execute the method of claim 18.

20. A method of incorporating a seed in a television signal, comprising:
fetching data picture elements;
generating noise picture elements for at least one selected seed;
adding the noise picture elements to the data picture elements yielding an output picture signal;
analyzing the output picture signal manually, or automatically analyzing the noise addition according to a predetermined quality determination method applying pre-programmed heuristics, either method yielding a decision output equal to PASS or FAIL;
automatically incorporating the currently selected and analyzed seed in the television signal if the decision output equals PASS, and continuing with the generating step for a new selected seed if the decision output equals FAIL.
